(19) United States
(12) Patent Application Publication
(10) Pub. No.: US 2017/0009857 A1
(43) Pub. Date: Jan. 12, 2017

(54) CABLE CYLINDER PROVIDED WITH AN ANTI-ROTATION DEVICE HAVING AN ELONGATE ELEMENT WHICH IS FLEXIBLE BUT RIGID WHEN TWISTED

(71) Applicant: COMMISSARIAT A L'ENERGIE ATOMIQUE ET AUX ENERGIES ALTERNATIVES, Paris (FR)

(72) Inventor: Philippe GARREC, Gif-sur-Yvette (FR)

(73) Assignee: COMMISSARIAT A L'ENERGIE ATOMIQUE ET AUX ENERGIES ALTERNATIVES, PARIS (FR)

(21) Appl. No.: 15/115,108

(22) PCT Filed: Feb. 24, 2015
(86) PCT No.: PCT/EP2015/053836

§ 371 Date: Jul. 28, 2016

(30) Foreign Application Priority Data
Mar. 10, 2014 (FR) 14 51962

(51) Int. Cl. F16H 25/20; F16H 19/06

(52) U.S. Cl. CPC F16H 25/20; F16H 19/06; F16H 2025/204

(57) ABSTRACT

The invention relates to a cable cylinder comprising a pin and nut device (2, 3), one of the elements of which is rotated about an axis of rotation (X) by a motor (10) and the other element is made to slide without rotating about the axis of rotation owing to an anti-rotation device, the sliding element being coupled to a cable (6) wrapped around a drive pulley (7) such that rotating the motor causes the linear movement of the sliding element, said sliding element pulling on the cable and thus rotating the drive pulley. The anti-rotation device comprises at least one elongate element (10) which is flexible but rigid when twisted, one end (11) of which is attached to the sliding element and a second end (12) of which is attached to a stationary portion of the cylinder, such that the elongate element is substantially curved in a plane parallel to the axis of rotation.

The invention relates to an anti-rotation device for the sliding portion of a cylinder which is activated by a rotating portion by means of a helical linking mean and a cable cylinder provided with an anti-rotation device of this kind. The invention relates, in particular, to grippers comprising phalanges provided for orthotics or prosthetics.

### BACKGROUND TO THE INVENTION

Cable cylinders used in particular to activate robot arms are known in the art. These cylinders comprise a screw and nut assembly, whereof one of the elements is rotated by a motor and the other element is forced by an anti-rotation device to slide during a rotation of the motor. The sliding element is coupled to a cable to exert a tractive force thereon in one direction or another. The cable is wrapped about a drive pulley which is attached to a turning pivot adapted to rotate an arm segment or any other element which has to be controlled when rotated.

The cylinder may be unilateral (open cable, one end of which is linked to the sliding element, the other end being associated with a tension spring) or bilateral (the cable forms a loop between the drive pulley and a return pulley). The motor drives the turning element by any appropriate device, such as a belt or reducing gear.

Moreover, the cable may be single or double. In this latter case, it is advantageously coupled to the sliding element by means of an anchoring member integral with the sliding element but movable in respect of said sliding element, the movable anchoring member then serving to balance the tractive forces between the two cables.

These cable cylinders are particularly used to activate finger phalanges of gripper devices. In effect, these cylinders have a plurality of competitive advantages over gear reducers in the realization of stress control actuators embedded in the articulated structures:
longitudinal motor therefore allowing the integration of an elongate motor in a segment, irrespective of whether the articulation of the segment is transverse or longitudinal;
low friction and low inertia reflected on the articulation (high transparency), especially thanks to the floating assembly described in document FR2809464;
lack of performance sensitivity in respect of deformations of the reception structure (no jamming or frictional variation).

In the case of robotic hands, the control of multiple phalanges requires a large number of actuators (typically 3 actuators per phalange) to be grouped in the equivalent volume of the palm. The volume of the electric motors in this location represents a significant constraint (in thickness or length). An excessively long palm, for example, leads to a lengthening of the phalanges so that a palm grip is still possible, and this tends to reduce the tightening force for an actuator.

It may then be decided to shift the motor in the up-stream segment (forearm) , thanks to transmission by means of a flexible drive shaft, where appropriate with a flexible sheath, as illustrated in document FR2990485. This shifting can be achieved while retaining a sufficient angle between the forearm and the palm.

This means that all that would then be left in the palm would be the conversion device of the rotational movement of the motor into a linear movement of the sliding element, a linear movement that is exploited in order to drive the cable.

More particularly, the invention relates to an anti-rotation device which allows this sliding to take place while preventing the sliding element from turning about the axis of rotation of the rotating element. A plurality of devices is known to the person skilled in the art. In particular, the provision of the sliding element with a mount in the form of an Oldham joint comprising diametrically opposite rollers made to slide in grooves which are parallel to the sliding direction of the sliding element and preventing any rotation of the sliding element about the axis of rotation of the rotating element is known from document FR 2 981 420.

These anti-rotation devices prove bulky, especially when a plurality of cylinders has to be joined one to the other in order to actuate a plurality of phalanges. Moreover, they are complex to produce, since they involve the making of grooves with precise dimensions, as well as the rotational guiding of rollers on pivots.

Moreover, it has been proposed that a bellows should be used to achieve the anti-rotation of the sliding element, as illustrated in document FR 2 856 452. The torsional rigidity of the bellows prevents the sliding element from turning about the axis of rotation of the turning element. However, a bellows of this kind is ill-suited to use in a cable cylinder.

### OBJECT OF THE INVENTION

The object of the invention is to propose a particularly simple and compact anti-rotation device that can be advantageously used in the cable cylinders of phalanges of gripper hands.

### REPRESENTATION OF THE INVENTION

With a view to achieving this goal, a cable cylinder is proposed comprising a screw and nut device, whereof one of the elements is rotated about an axis of rotation by a motor and the other of the elements is forced to slide without turning about the axis of rotation, thanks to an anti-rotation device, the sliding element being coupled to a cable wrapped about a drive pulley such that a rotation of the motor causes the linear displacement of the sliding element, said sliding element pulling the cable and thereby causing the drive pulley to turn. According to the invention, the anti-rotation device comprises at least one elongate element which is flexible but rigid when twisted, a first end whereof is attached to the sliding element and a second end is attached to a stationary portion of the cylinder, such that the elongate element is substantially curved in a plane parallel to the axis of rotation.

The elongate element prevents any rotation of the sliding element due to its torsional rigidity, but follows the longitudinal movements of the sliding element by bending on account of its flexibility. This anti-rotation device is very easy to put into operation with only the attachment of the ends of the elongate element having to be provided for.

The first end and the second end of the elongate element are preferably attached to the sliding element and to the stationary portion of the cylinder, respectively, on either side of the axis of rotation. Hence, the curve of the elongate element is formed in front of said stationary portion and the space required by the cylinder is reduced by this.

According to a particular embodiment, the anti-rotation device comprises two elongate elements, the first ends whereof are attached in a diametrically opposite manner to the sliding element, such that the curved elongate elements extend in parallel planes.

According to a particular aspect of the invention, the elongate element is a flexible drive shaft. Hence, the flexible drive shaft is in no way used for its usual function which is the transmission of a torque between a motor and an operated part. The great torsional rigidity of the flexible drive shafts is exploited to ensure the anti-rotation of the sliding element of the cable cylinder.

### DESCRIPTION OF THE FIGURES

The invention will be better understood in light of the following description of particular non-limiting embodiments of the invention, with reference to the figures in the attached drawings, among which:

FIG. 1 is an outline schematic of a cable cylinder according to the invention, the sliding element in this case being the screw;

FIGS. 2a to 2c illustrate the longitudinal displacement of the screw of the cylinder in FIG. 1;

FIGS. 3a to 3c are similar figures to FIGS. 2a to 2c, illustrating a cylinder, whereof the sliding element is the nut;

FIGS. 4a to 4c are similar figures to FIGS. 2a to 2c, illustrating a cylinder with two elongate elements;

FIGS. 5a to 5c are similar figures to FIGS. 4a to 4c, illustrating a cylinder with two elongate elements;

FIGS. 6a and 6b are schematic side and front views of a cylinder assembly according to FIGS. 4a to 4c;

FIGS. 7a and 7b are schematic side and front views of a cylinder assembly according to FIGS. 4a to 4c;

FIGS. 8a and 8b are schematic side and front views of a cylinder assembly according to FIGS. 5a to 5c.

### DETAILED DESCRIPTION OF EMBODIMENTS OF THE INVENTION

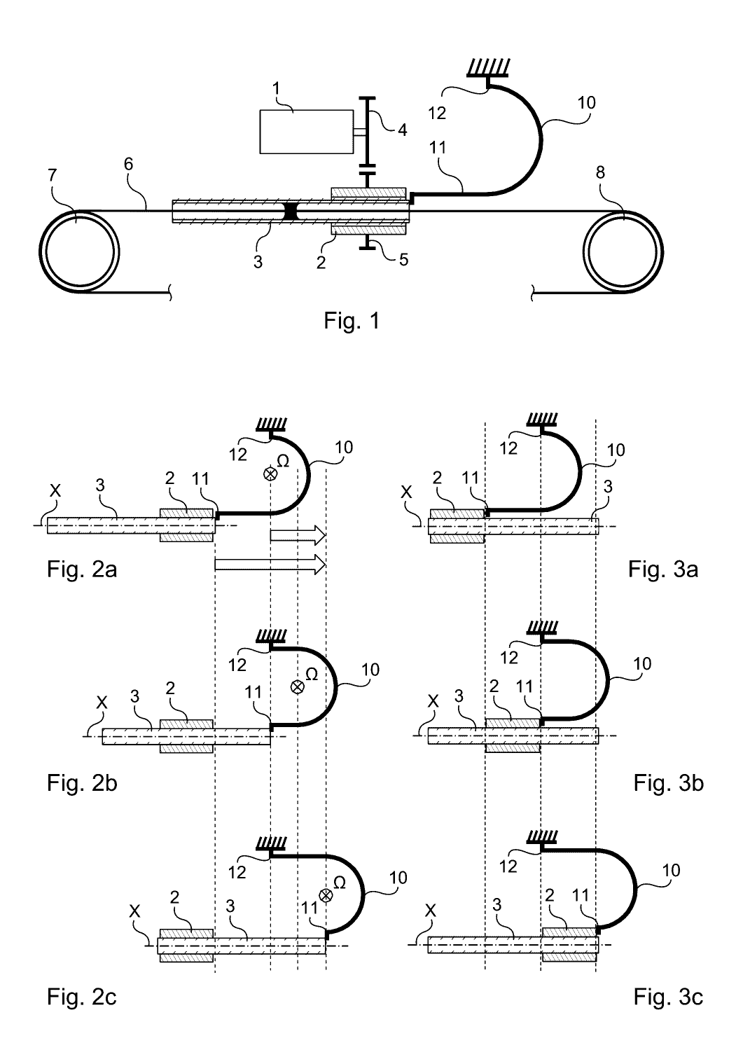

With reference to FIG. 1, and in accordance with a first embodiment of the invention, the cable cylinder comprises a motor 1 adapted to rotate a nut 2 which cooperates with a screw 3 which is displaced longitudinally along an axis X of rotation of the nut 2 in response to a rotation of the motor 1. In this case, the motor 1 drives the nut 2 by means of a belt link, the pulleys 4 and 5 whereof are depicted in schematic form. A cable 6 is stretched between a drive pulley 7 and a return pulley 8. The cable 6 passes on the inside of the screw 3 (which is hollow) and is coupled to said screw in such a manner that a displacement of the screw 3 causes an unwinding of the cable 6 and therefore a rotation of the drive pulley 7.

The foregoing is referred to simply by way of illustration of the background art. The invention which will now be specified applies to this kind of cylinder, but it is not limited to this kind of cylinder. In particular, the cylinder may exhibit a motor shift by means of a flexible drive shaft; the cable can only be wrapped about the only drive pulley, a spring keeping it taut. The cylinder may exhibit two cables.

According to the invention, the screw 7 is prevented from turning about the axis X by means of an anti-rotation device, in this case comprising an elongate element 10 which is flexible but exhibits great rigidity when twisted, having a first end 11 attached to the screw 3 and a second end 12 attached to a chassis of the cable cylinder. The elongate element 10 is curved and extends substantially according to a plane parallel to the axis X.

FIGS. 2a to 2c illustrate the behavior of the elongate element 10 when the screw 3 is displaced due to the action of the motor 1. It can be seen that the second end 12 of course remains stationary, but that the instantaneous center of curvature C2 of the curved portion of the elongate element 10 advances with the screw 3, the elongate element 10 substantially extending in the same plane. The elongate element 10 prevents the screw 3 from turning and therefore constitutes an anti-rotation device thereof. It will be noted that the plane in which the elongate element 10 extends may turn slightly during the displacement of the screw 3, which in no way affects the functioning of the cylinder. Likewise, if the stresses on the elongate element are significant, said element may become deformed in a non-planar manner, which in no way affects the operation of the cylinder. It is important, however, to ensure that the elongate element 10 remains stable under the effects of gravity and stress, which limits its length and therefore the path of the cylinder.

FIGS. 3a to 3c illustrate a variant of the cylinder in FIG. 1 in which the motor 1 is adapted to rotate the screw 3. It is then the nut 2 which is displaced longitudinally under the effect of the rotation of the motor, the cable then being coupled to the nut 2. Of course, the elongate element 10 is now coupled to the nut 2. It can be seen that the second end 12 of course remains stationary, but that the instantaneous center of curvature C2 advances with the nut 2, the elongate element extending substantially in the same plane P, with small torsional deformations close by.

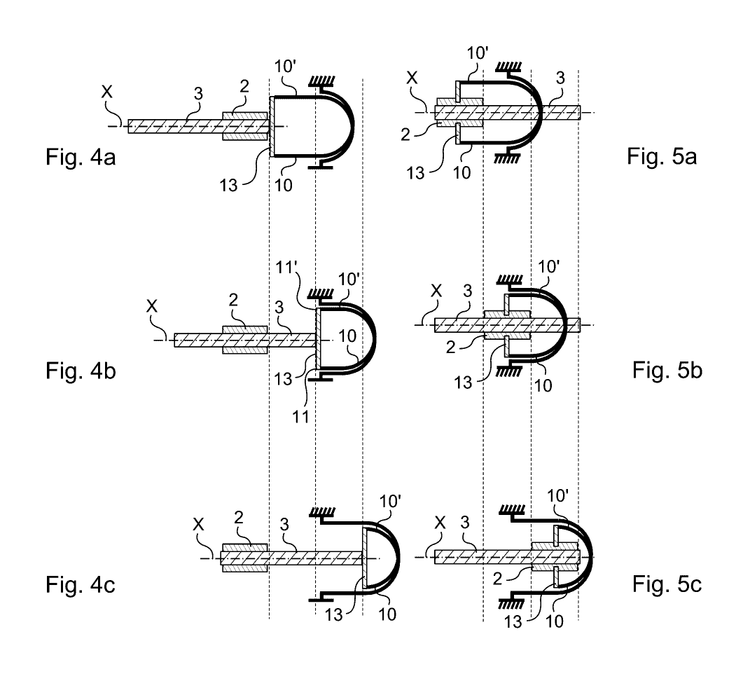

FIGS. 4a to 4c relate to a cable cylinder similar to that in FIGS. 2a to 2c, except that it is provided with two elongate elements 10 and 10′ which are attached to the screw 3 by means of an anchoring member 13 having the shape of a bar connected to the end of the screw 3. The first ends 11 and 11′ are fixed to the ends of the bar in a diametrically opposite manner on either side of the axis X. It will be noted that for each of the elongate elements 10,10′, their ends extend on either side of the axis of rotation X. The two elongate elements 10,10′ extend in two planes parallel to one another. It will be ensured that the planes of the two elongate elements are sufficiently spaced apart, in order to avoid any interference between them in the event of non-planar deformation.

The use of two elongate elements coupled in a diametrically opposite manner to the sliding element of the cable cylinder allows the parasitic forces endured by the sliding element due to the presence of the elongate elements to be balanced.

FIGS. 5a to 5c show the use of two elongate elements 10 and 10′ in the framework of a cable cylinder, whereof the sliding element is the nut 2. The anchoring member 13 is now attached to the nut 2.

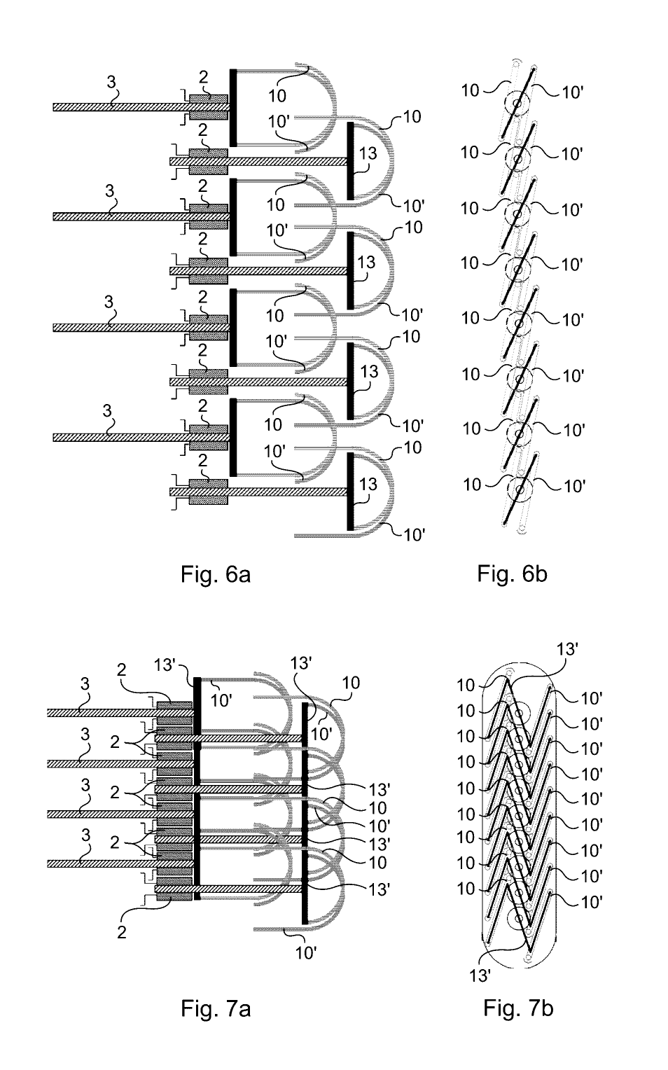

FIGS. 6a and 6b show how cylinders of this kind can be attached in a compact assembly, in order to ensure the actuation of phalanges of fingers in a robotic hand, for example. Only the screw/nut assembly of each of the cylinders has been represented here. In this case, it is the screws 3 which form the sliding element, the nuts 2 being rotated by their respective motor. The axes of rotation of the screw/nut devices are all parallel to one another in this case and extend in a same plane.

All the elongate elements 10,10′ of said cylinders extend in parallel planes to one another. The anchoring members 13 are equally parallel to one another. Just as is more particularly visible in FIG. 6b, the planes of the elongate elements are interconnected with one another, such that an elongate element of a cylinder is enclosed by the two elongate elements of an adjacent cylinder (except, of course, in the case of the end cylinders). This arrangement is very flat. It will be noted in FIG. 6a that, at least for the intermediate cylinders, the plane of one of the elongate elements converges towards the axis of the adjacent screw, such that the end 12 of an elongate element which is coupled to a stationary portion of the cylinder does not go beyond the screw of the adjacent cylinder.

FIGS. 7a and 7b show an arrangement which is even more compact in terms of height, although this is at the expense of a greater width. In this case, the arrangement always relates to cylinders in which the screw is the sliding element. It will be noted that the elongate elements 10 and 10′ always extend in parallel planes. To this end, the anchoring members 13′, which are always coupled to the screw, are now in a Z shape. The anchoring members 13′ are connected to the screw 3 by means of their central branch. This arrangement allows it to be ensured that the planes of the elongate elements extend along the sides of the screws, which allows them to interconnect in a more compact manner.

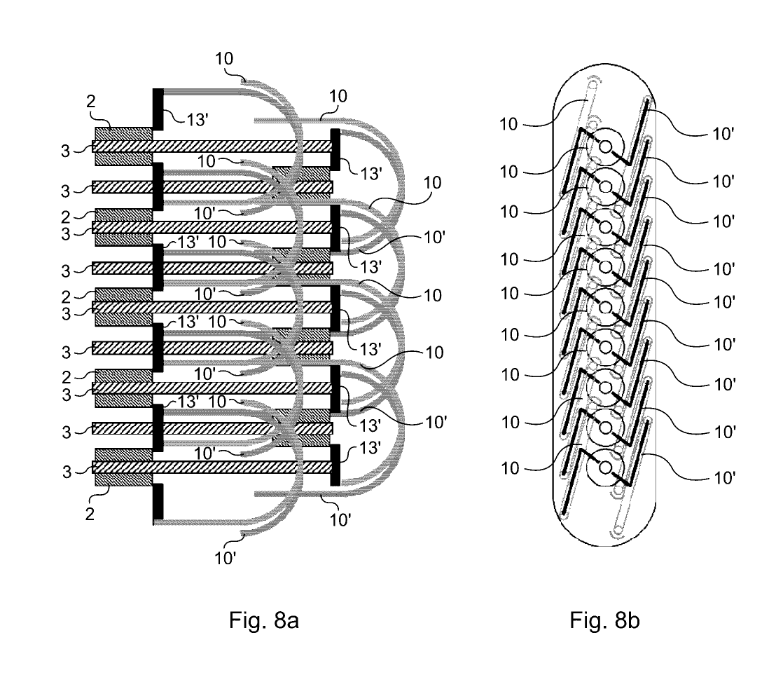

FIGS. 8a and 8b show a similar arrangement to the one in FIGS. 7a and 7b, for cylinders in which the sliding element is now the nut 2.

Each elongate element 10 is preferably made up of a flexible drive shaft of the same kind as those which are used in cable cylinders to drive the rotating element by means of a shifted motor. This kind of elongate motor is flexible, while exhibiting great rigidity when twisted.

The invention is not limited to what has just been described; on the contrary, it encompasses any variant that falls within the framework defined by the claims.

1. A cable cylinder comprising a screw and nut device, whereof one of the screw and nut elements is rotated about an axis of rotation by a motor and the other of the screw and nut elements, the sliding element, is forced to slide without turning about the axis of rotation, thanks to an anti-rotation device, the sliding element being coupled to a cable wrapped about a drive pulley such that a rotation of the motor causes the linear displacement of the sliding element, said sliding element pulling the cable and thereby causing the drive pulley to turn, characterized in that the anti-rotation device comprises at least one elongate element which is flexible but rigid when twisted, a first end whereof is attached to the sliding element and a second end is attached to a stationary portion of the cylinder, such that the elongate element is substantially curved in a plane parallel to the axis of rotation.

2. The cable cylinder as claimed in claim 1, wherein the first end and the second end of the elongate element are attached to the sliding element and to the stationary portion of the cylinder, respectively, on either side of the axis of rotation.

3. The cable cylinder as claimed in claim 1, wherein the anti-rotation device comprises two elongate elements, the first ends whereof are attached in a diametrically opposite manner to the sliding element, such that the curved elongate elements extend in parallel planes.

4. The cable cylinder as claimed in claim 3, wherein the first ends of the elongate elements are attached to the sliding element by means of an anchoring member connected to the sliding element.

5. The cable cylinder as claimed in claim 3, wherein the first and second ends of the elongate elements extend on either side of the axis of rotation.

6. The cable cylinder as claimed in claim 1, wherein the elongate element is a flexible drive shaft.

7. An assembly of cable cylinders as claimed in claim 1, the cylinders being juxtaposed in respect of one another, such that the axes of rotation of their respective screw and nut devices are parallel to one another and extend in a same plane, the elongate elements extending in planes which are parallel to one another.

8. The assembly of cable cylinders as claimed in claim 6, wherein the plane of one of the elongate elements of one of the cylinders converges towards the axis of rotation of the screw and nut device of the adjacent cylinder.
